(19) United States
(12) Patent Application Publication
(10) Pub. No.: US 2018/0293249 A1
(43) Pub. Date: Oct. 11, 2018

(54) SYSTEM AND METHOD FOR UTILIZING PREFERENCES TO CURATE VENUES BASED ON DATA

(71) Applicant: Flock Tonight, Inc., Miami Beach, FL (US)

(72) Inventor: Alain Tabares, Miami Beach, FL (US)

(73) Assignee: Flock Tonight, Inc., Miami Beach, FL (US)

(21) Appl. No.: 15/948,340

(22) Filed: Apr. 9, 2018

Related U.S. Application Data
(60) Provisional application No. 62/482,972, filed on Apr. 7, 2017.

(51) Int. Cl. G06F 17/30; G06Q 30/02; H04W 4/02; H04L 29/12

(52) U.S. Cl. CPC G06F 17/3087; G06F 17/30867; H04L 61/609; H04W 4/023; G06Q 30/0203

(57) ABSTRACT

A system for utilizing preferences and demographic information obtained from data sources to curate venues is disclosed. In particular, the system may determine a user's location through a variety of techniques and then utilize the user's location to determine localities within a first threshold distance of the user's location. The system filters the localities based on the preferences and demographic information, and then cause the filtered results to be displayed with the preferences and demographic information. If the user is within a second threshold distance of a locality in the filtered results, the system provides an option to electronically check into the locality. Once the user is checked in, the preferences and demographic information for the user is averaged with corresponding information for other users for the locality. When a subsequent user views the same locality in his own search results, the averaged information is provided to the subsequent user.

### CROSS REFERENCE TO RELATED APPLICATIONS AND PRIORITY

The present application claims priority to and the benefit of U.S. Provisional Application No. 62/482,972, filed Apr. 7, 2017, the entirety of which is hereby incorporated by reference.

### FIELD OF THE INVENTION

The present application relates to web service technologies, data aggregation, manipulation, and analysis technologies, tracking technologies, and computing technologies, and more particularly, to a system and method for utilizing preferences to curate venues based on data obtained from a variety of sources.

### BACKGROUND

In today's technologically-driven society, there exist various systems and methods for assisting users in finding various locations of interest. For example, a particular business may have an online website that may be made accessible to users to enable the users to readily view contact information for the business, address information for the business, products provided by the business, a description of what services the business provides, or other information. Additionally, users have the ability to search online reviews of venues to determine if a particular venue correlates with their preferences. Furthermore, there exist certain mapping software programs that display possible locations of interest for a given geographic area. While such technologies exist today, such technologies and processes still have many shortcomings. For example, even though many venues have online websites to reach users, such websites are often difficult for users to navigate and do not provide enough relevant information to a user to make an effective decision as to whether or not to visit the venue at the present time. Additionally, current technologies and processes technologies and processes are often error-prone, provide a lot of irrelevant information, and may be difficult to implement. Moreover, while current technologies have been utilized to attract users to various venues, currently existing technologies have not provided optimal ways of doing so. Still further, currently existing technologies do not effectively utilize computing resources. As a result, current technologies and processes may be modified and improved so as to provide enhanced functionality and features for users to locate venues of interest in an expeditious and effective manner. Such enhancements and improvements may provide for improved user satisfaction, increased efficiencies, increased access to meaningful data, substantially-improved decision-making abilities, and increased ease-of-use for users, while simultaneously optimizing the use of computing resources.

### SUMMARY

A system and method for utilizing preferences to curate venues based on data obtained from a variety of sources are disclosed. In particular, the system and accompanying methods provide for a web service that collects and curates information for users based on demographics of crowds at various types of venues of interest. Additionally, the system and accompanying methods provide a novel way for searching for localities and venues of interest. To that end, the system and methods may utilize a website, an application, or other software program that allows for the real-time display of demographics of individuals at one or more places of gathering, such as, but not limited to, a restaurant, bar, hotel, business, or other venue, so as to enable a user to rapidly determine whether or not the user wants to visit the particular venue. In certain embodiments, the system and methods may allow for the filtering of venues based on user preference information, demographic information, and/or account information received from a user. For example, the venues may be filtered based on any combination of demographic information including, but not limited to, desired age ranges, desired gender ratios, desired ethnicity distributions, desired energy levels, desired culture types, desired nationality, desired heritage, desired attire, any other demographic information, or any other information. Also, the system and methods may include determining a location of a user, and allow a user to check into a locality that is within a threshold distance of the user and/or the user's device. If the user checks into the locality, the system and method may include creating a digital survey, which the user may utilize to input additional demographic information or other information corresponding to the locality. The information submitted by the user may be utilized to update the real-time demographic information for the locality so that subsequent users may view the updated demographic information for the locality in real-time so as to make an effective decision regarding visiting the locality.

In one embodiment, a system for utilizing preferences to curate venues based on data obtained from a variety of sources is disclosed. The system may include a memory that stores instructions and a processor that executes the instructions to perform operations conducted by the system. The system may receive, from a communication device, demographic information and preferences corresponding to a user. The system may then determine, based information associated with the communication device, a location of the user. Based on the location of the user, the system may determine a plurality of localities within a first threshold distance of the location of the user. Based on the demographic information and the preferences, the system may filter the plurality of localities to obtain a subset of localities relevant to the user. The system may then cause the subset of localities and locality demographic information specific to each locality in the subset of localities to be displayed on the communication device. The system may then proceed to determine, based on the information associated with the communication device, if the user is within a second threshold distance of a first locality of the subset of localities. If the user is within the second threshold distance of the first locality, the system may provide an option to check into the first locality, such as via the communication device. If the option to check into the first locality is selected, the system may associate the demographic information of the user to the first locality. The system may then proceed to update the locality demographic information specific to the first locality based on the demographic information of the user that has been associated with the first locality.

In another embodiment, a method for utilizing preferences to curate venues based on data obtained from a variety of sources is disclosed. The method may include utilizing a memory that stores instructions, and a processor that executes the instructions to perform the various functions of the method. In particular, the method may include receiving, from a communication device, demographic information and preferences corresponding to a user. Additionally, the method may include determining, based information associated with the communication device, a location of the user. The method may then include calculating, based on the location of the user, a plurality of localities within a first threshold distance of the location of the user. Based on the demographic information and the preferences, the method may include filtering the plurality of localities to obtain a subset of localities relevant to the user. The method may then include causing the subset of localities and locality demographic information specific to each locality in the subset of localities to be displayed on the communication device. Based on the information associated with the communication device, the method may include determining if the user is within a second threshold distance of a first locality of the subset of localities. The method may include providing, to the communication device and if the user is within the second threshold distance of the first locality, an option to check into the first locality. If the option to check into the first locality is selected, the method may include associating the demographic information of the user to the first locality. Finally, the method may include updating locality demographic information specific to the first locality based on the demographic information of the user that has been associated with the first locality.

According to yet another embodiment, a computer-readable device having instructions for utilizing preferences to curate venues based on data obtained from a variety of sources is provided. The computer instructions, which when loaded and executed by a processor, may cause the processor to perform operations including: providing receiving, from a communication device, demographic information and preferences corresponding to a user; determining, based information associated with the communication device, a location of the user; calculating, based on the location of the user, a plurality of localities within a first threshold distance of the location of the user; filtering, based on the demographic information and the preferences, the plurality of localities to obtain a subset of localities relevant to the user; causing the subset of localities and locality demographic information specific to each locality in the subset of localities to be displayed on the communication device; determining, based on the information associated with the communication device, if the user is within a second threshold distance of a first locality of the subset of localities; providing, to the communication device and if the user is within the second threshold distance of the first locality, an option to check into the first locality; associating, if the option to check into the first locality is selected, the demographic information of the user to the first locality; and updating locality demographic information specific to the first locality based on the demographic information of the user that has been associated with the first locality.

These and other features of the systems and methods utilizing preferences to curate venues based on data obtained from a variety of sources are described in the following detailed description, drawings, and appended claims.

### BRIEF DESCRIPTION OF THE DRAWINGS

FIG. 1 is a schematic diagram of a system for utilizing preferences and demographic information to curate venues and/or localities based on data obtained from a variety of sources according to an embodiment of the present disclosure.

FIG. 2 is a diagram illustrating a digital form for a user to create an account with an application of the system of FIG. 1.

FIG. 3 is a diagram illustrating a web page produced by the system of FIG. 1, which features real-time demographic information for various localities and/or venues.

FIG. 4 is a diagram illustrating a web page produced by the system of FIG. 1, which features an ability for a user to check into a locality via an application of the system of FIG. 1.

FIG. 5 is a diagram illustrating a digital survey produced by the system of FIG. 1, which is configured to receive demographic and other information.

FIG. 6 is a diagram illustrating a digital survey produced by the system of FIG. 1, which is configured to receive additional demographic and other information.

FIG. 7 is a diagram illustrating a web page produced by the system of FIG. 1, which illustrates real-time demographic information for a selected locality.

FIG. 8 is a flow diagram illustrating a sample method for utilizing preferences and demographic information to curate venues and/or localities based on data obtained from a variety of sources according to an embodiment of the present disclosure.

FIG. 9 is a schematic diagram of a machine in the form of a computer system within which a set of instructions, when executed, may cause the machine to perform any one or more of the methodologies or operations of the systems and methods for utilizing preferences and demographic information to curate venues and/or localities based on data obtained from a variety of sources.

### DETAILED DESCRIPTION OF THE INVENTION

A system 100 and method for utilizing preferences to curate venues based on data obtained from a variety of sources are disclosed. In particular, the system 100 and accompanying methods provide for a web service that collects and curates information for users based on demographics of crowds at various types of venues of interest. Additionally, the system 100 and accompanying methods provide a novel way for searching for localities and venues of interest. To that end, the system 100 and methods may utilize a website, an application, or other software program that allows for the real-time display of demographics of individuals at one or more places of gathering, such as, but not limited to, a restaurant, bar, hotel, business or other venue, so as to enable a user to rapidly determine whether or not the user wants to visit the particular venue. In certain embodiments, the system 100 and methods may allow for the filtering of venues based on user preference information, demographic information, and/or account information received from a user. For example, the venues may be filtered based on any combination of demographic information including, but not limited to, desired age ranges, desired gender ratios, desired ethnicity distributions, desired energy levels, desired culture types, desired nationality, desired heritage, desired attire, or any other demographic information. Also, the system 100 and methods may include determining a location of a user, and allow a user to check into a locality that is within a threshold distance of the user and/or the user's device. If the user checks into the locality, the system 100 and method may include creating a digital survey, which the user may be utilized to input additional demographic information or other information corresponding to the locality. The information submitted by the user may be utilized to update the real-time demographic information for the locality so that subsequent users may view the updated demographic information for the locality in real-time so as to make an effective decision regarding visiting the locality.

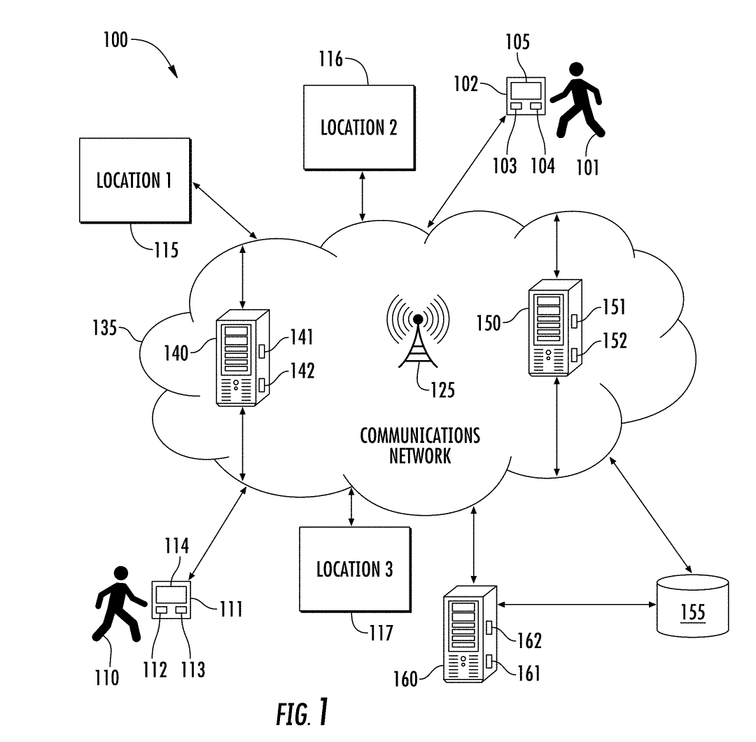

As shown in FIGS. 1-9, a system 100 for utilizing preferences and demographic information to curate venues and/or localities based on data obtained from a variety of sources is disclosed. The system 100 may be configured to support, but is not limited to supporting, data and content services, computing applications and services, cloud computing services, internet services, satellite services, telephone services, software as a service (SaaS) applications, mobile applications and services, and any other computing applications and services. The system may include a first user 101, who may utilize a first user device 102 to access data, content, and applications, or to perform a variety of other tasks and functions. As an example, the first user 101 may utilize first user device 102 to access an application (e.g. a browser or a mobile application) executing on the first user device 102 that may be utilized to access web pages, data, and content associated with the system 100. In certain embodiments, the first user 101 may be any type of user that may be searching for various localities to visit. For example, the first user 101 may be an individual that is searching for a venue or locality that conforms to his interests. Such localities and venues may include, but are not limited to, restaurants, bars, clubs, hotels, businesses, theme parks, private locations, public locations, parks, airports, movie theaters, beaches, any type of location, or any combination thereof. The first user device 102 utilized by the first user 101 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102, to interact with various applications executing within the system 100, and to interact with the system 100. In certain embodiments, the first user device 102 may be a computer, a laptop, a tablet device, a phablet, a server, a mobile device, a smartphone, a smart watch, and/or any other type of computing device. Illustratively, the first user device 102 is shown as a mobile device in FIG. 1. The first user device 102 may also include a global positioning system (GPS), which may include a GPS receiver and any other necessary components for enabling GPS functionality.

In addition to the first user 101, the system 100 may include a second user 110, who may utilize a second user device 111 to access data, content, and applications, or to perform a variety of other tasks and functions. The second user 110 may also be searching for a venue or locality to visit. Much like the first user 101, the second user 110 may utilize second user device 111 to access an application (e.g. a browser or a mobile application) executing on the second user device 111 that may be utilized to access web pages, data, and content associated with the system 100. The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. a screen, a monitor, a graphical user interface, etc.) that may enable the second user 110 to interact with various applications executing on the second user device 111, to interact with various applications executing in the system 100, and to interact with the system 100. In certain embodiments, the second user device 111 may be a computer, a laptop, a tablet device, a phablet, a server, a mobile device, a smartphone, a smart watch, and/or any other type of computing device. Illustratively, the second user device 111 may be a computing device in FIG. 1.

In certain embodiments, the first user device 102 and the second user device 111 may have any number of software applications and/or application services stored and/or accessible thereon. For example, the first and second user devices 102, 111 may include cloud-based applications, location-determining applications, GPS applications, database applications, algorithmic applications, phone-based applications, product-ordering applications, business applications, e-commerce applications, media streaming applications, content-based applications, database applications, gaming applications, internet-based applications, browser applications, mobile applications, service-based applications, productivity applications, video applications, music applications, social media applications, any other type of applications, any types of application services, or a combination thereof. In certain embodiments, the software applications and services may include one or more graphical user interfaces so as to enable the first and second users 101, 110 to readily interact with the software applications. The software applications and services may also be utilized by the first and second users 101, 110 to interact with any device in the system 100, any network in the system 100, or any combination thereof. For example, the software applications executing on the first and second user devices 102, 111 may be applications for receiving data, applications for storing data, applications for determining locations of users and devices, applications for receiving demographic and preference information, applications for transforming data, applications for executing mathematical algorithms, applications for generating and transmitting electronic messages, applications for generating and transmitting various types of content, any other type of applications, or a combination thereof. In certain embodiments, the first and second user devices 102, 111 may include associated telephone numbers, internet protocol addresses, device identities, or any other identifiers to uniquely identify the first and second user devices 102, 111. In certain embodiments, location information corresponding to the first and second user devices 102, 111 may be obtained based on the internet protocol addresses.

The system 100 may also include one or more cell towers 125, which may include any number of antennae to facilitate communications for the devices, applications, and networks in the system 100. The cell tower 125 may be utilized to create a cell for the communications network 135. Each cell tower 125 may include an identifier that is utilized to identify the cell tower 125 to any of the networks, devices, and programs in the system 100. The identifier may be a sequence of numbers, characters, or any combination thereof that uniquely identify the cell tower 125. In certain embodiments, the cell tower 125 may be a base station or other similar station, and may include any of the functionality and features of any type of cell site or tower. In certain embodiments, the cell tower 125 may be utilized to facilitate communications for the first and second user devices 102, 111, the locations 115-117, the servers 140, 150, 160, the database 155, any other components of the system 100 or outside the system 100, or any combination thereof.

The system 100 may also include a communications network 135. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry, and may be controlled by a service provider. The communications network 135 may also include and be connected to a cloud-computing network, a phone network, a wireless network, an Ethernet network, a satellite network, a broadband network, a cellular network, a private network, a cable network, the Internet, an internet protocol network, a content distribution network, any network, or any combination thereof. Illustratively, cell tower 125, server 140, and server 150 are shown as being included within communications network 135.

Notably, the functionality of the system 100 may be supported and executed by using any combination of the servers 140, 150, and 160. The servers 140, and 150 may reside in communications network 135, however, in certain embodiments, the servers 140, 150 may reside outside communications network 135. The servers 140, and 150 may be utilized to perform the various operations and functions provided by the system 100, such as those requested by applications executing on the first and second user devices 102, 111. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 150 may include a memory 151 that includes instructions, and a processor 152 that executes the instructions from the memory 151 to perform the various operations that are performed by the server 150. In certain embodiments, the servers 140, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 150 may be communicatively linked to the communications network 135, any network, any device in the system 100, or any combination thereof.

The database 155 of the system 100 may be utilized to store and relay information that traverses the system 100, cache information and/or content that traverses the system 100, store data about each of the devices in the system 100, and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or be connected to a processor and memory to perform the various operations associated with the database 155. In certain embodiments, the database 155 may be connected to the servers 140, 150, 160, the first user device 102, the second user device 111, any devices in the system 100, any other device, any network, or any combination thereof.

The database 155 may also store information obtained from the system 100, store information associated with the first and second users 101, 110, store location information for the first and second user devices 102, 111 and/or first and second users 101, 110, store location information for the locations 115-117, store user profiles associated with the first and second users 101, 110, store device profiles associated with any device in the system 100, store communications traversing the system 100, store user preferences, store demographic information for the first and second users 101, 110 and/or the locations 115-117, store information associated with any device or signal in the system 100, store information relating to usage of applications accessed by the first and second user devices 102, 111, store any information obtained from any of the networks in the system 100, store historical data associated with the first and second users 101, 110, store device characteristics, store information relating to any devices associated with the first and second users 101, 110, or any combination thereof. The database 155 may store algorithms for calculating gender ratios, ethnicity distributions, averaging age ranges, averaging demographic information received for a particular locality from various users checked into the locality, any other algorithms for performing any other calculations in the system 100, or any combination thereof. In certain embodiments, the database 155 may be configured to store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

The system 100 may also include a software application, which may be configured to perform and support the operative functions of the system 100. In certain embodiments, the application may be a website, a mobile application, a software application, or a combination thereof, that may be made accessible to users utilizing one or more computing devices, such as first user device 102. The application may be utilized to determine and filter localities based on demographic information and user preference information received from the first and/or second user 101, 110, such as via the first and/or second user devices 102, 111. The application of the system 100 may be accessible via an internet connection established with a browser program executing on the first or second user devices 102, 111, a mobile application executing on the first or second user devices 102, 111, or through other suitable means. Additionally, the application may allow users and computing devices to create accounts with the application and sign-in to the created accounts with authenticating username and password log-in combinations. The application may include a custom graphical user interface that the first user 101 or second user 110 may interact with by utilizing the web browser executing on the first user device 102 or second user device 111.

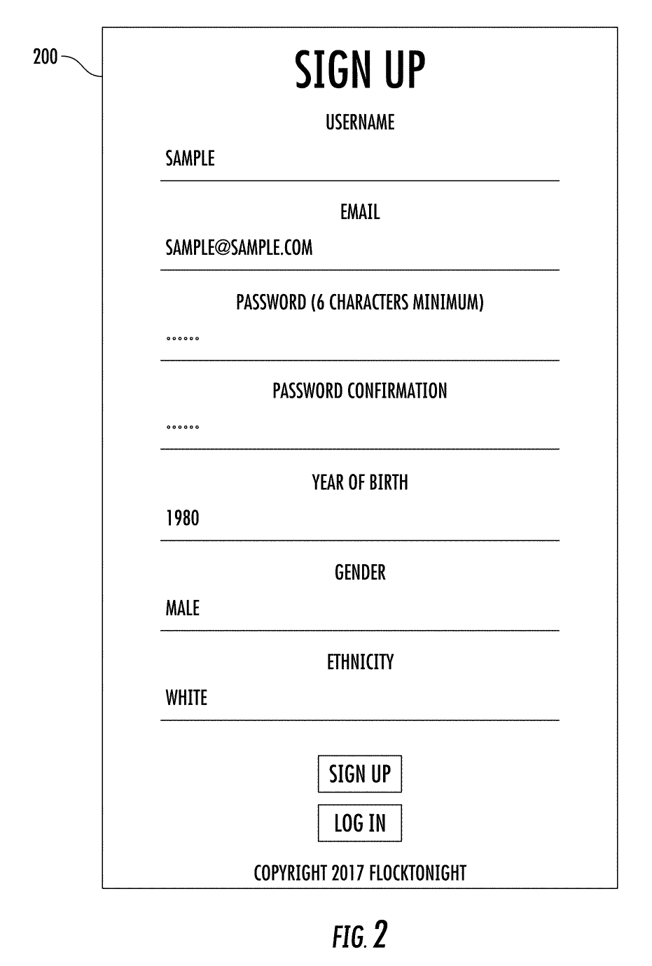

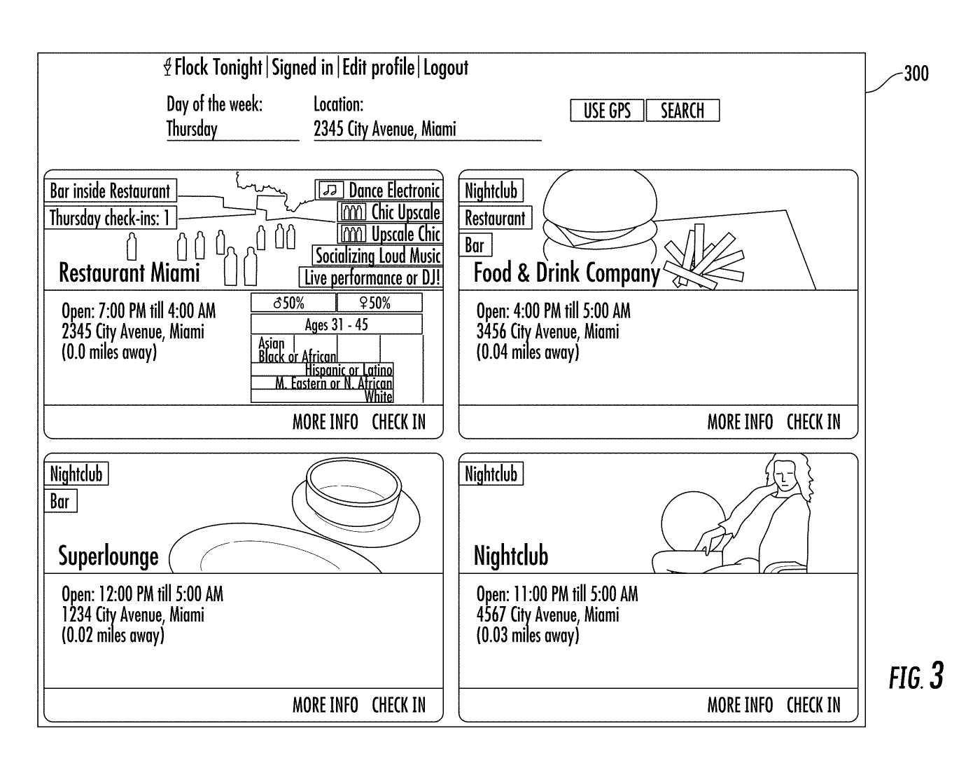

In certain embodiments, when the first user 101 (or second user 110) accesses the application, the application may generate web page 200, as shown in FIG. 2, which may allow the first user 101 to create an account with the application and/or system 100. The web page 200 may be a digital form that takes inputs for a username, password, email address, year of birth, gender, ethnicity, other information, or any combination thereof. Once such information is entered in the digital form on web page 200, the system 100 may save the information, including the demographic information, into the system 100 and associate the account with the application and the first user 101. The application may then allow the first user 101 to log into the application using the authentication credentials that the first user 101 entered into the digital form. If the first user 101 forgets their authentication credentials (e.g. password, username, etc.), the application may enable the first user 101 to submit their email address so that the authentication credentials may be emailed to the first user 101. Once the first user 101 logs into the application using the authentication credentials, the online portal may generate and display a web page 300, as shown in FIG. 3. The web page 300 may include information indicating a location of the first user 101, the first user device 102, a calendar, a feature for logging out of the application, a search function, a listing of venues/localities within a certain distance of the first user's 101 location, demographic information for each of the venues/localities, an ability to check into a venue or locality, a feature for accessing the first user's 101 profile including account information, preference information, and demographic information for the first user 101, any other information, or any combination thereof.

After the first user 101 has logged into the application, the system 100 may determine the user's location. The location of the first user 101 may be determined by determining the location of the first user device 102 that the first user 101 is using to access the application of the system 100. The location of the first user device 102 (and first user 101) may be determined by accessing a GPS receiver of the first user device 102, which may be utilized to provide longitude and latitude coordinates corresponding to the location of the first user device 102 to the application and/or to the system 100. The GPS receiver may receive the longitude and latitude coordinates based on communications conducted with one or more satellites. In certain embodiments, the location of the device may be determined by obtaining the location from the cell tower 125 or by accessing a cell identifier stored on the first user device 102 that identifies the location of the cell tower 125. In certain embodiments, the location of the first user device 102 may be obtained by utilizing cellular triangulation and/or by utilizing forward link trilateration. In certain embodiments, the location of the first user device 102 may be determined by measuring a signal strength of a cell connected to the first user device 102. In certain embodiments, the location of the device may be obtained by accessing measurements provided by a subscriber identity module of the first user device 102. The measurements may include signal-strength measurements, round-trip time measurements, a cell identifier of the cell tower 125 connected to the first user device 102, or any combination thereof. In certain embodiments, the location of the first user device 102 may be determined based on Wi-Fi data obtained from a wireless network connected to the first user device 102. In certain embodiments, the location of the first user device 102 may be determined based on a speech or text input received from the first user 101 via the first user device 102. In certain embodiments, the location of the first user device may be determined based on an internet protocol address of the first user device 102.

Depending on the method used to determine the first user device's 102 location, the obtained location information may be provided to one or more components of the system and/or to the application. For example, the GPS receiver of the first user device 102 may transmit the location information to the application, which may then transmit the location information to any other component of the system 100. The location information may include longitude and latitude coordinates, along with any other location information (e.g. city, state, address, zip code, block, etc.). Once the location information is obtained, the system 100 and/or application may calculate and/or determine localities (e.g. first location 115, second location 116, and third location 117) that are within a distance of the user's location. For example, the localities may be calculated based on the distance from the first user's 101 (and/or first user device 102) latitude and longitude coordinates. The determining may be initiated by a query received from the first user 101 via the application, automatically by the application upon the first user 101 logging into the application and/or system 100, automatically when the first user device 102 is turned on, or any combination thereof. Localities within the distance from the first user's 101 location may be determined by comparing the first user's 101 location information to location information corresponding to the localities, which may reside in database 155. In certain embodiments, all localities within the distance of the user's location may be determined. The system 100 and/or application may filter the localities based on the first user's 101 preference information, account information, demographic information, parameters received as input from the first user 101 via the first user device 102, or a combination thereof. For example, if the preference information, demographic information, and/or inputs indicate that the first user 101 prefers localities having at least a gender ratio of two females to one male, the system 100 may filter the localities to generate a subset of localities having a gender ratio of at least two females to one male.

The system 100 may cause the filtered locality results to be displayed on the first user device 102 of the first user 101. The results may be displayed via an interface of the application, through a browser program, or a combination thereof. In addition to displaying each locality to the first user 101, demographic information corresponding to each locality may be displayed in proximity to or in the vicinity of the displayed locality. For example, in FIG. 3, one of the localities displayed to the first user 101 is “Alain's Awesome Nightclub.” The system 100 may display the distance that the nightclub is from the first user 101, the time of operation for the nightclub, the price range of beverages and food at the nightclub, the gender ratio of individuals currently at the nightclub, the ethnic distribution of individuals at the nightclub, the age range of individuals at the nightclub, the energy level of individuals at the nightclub, the types of music being played at the nightclub, the type of attire for the nightclub, the culture at the nightclub, the type of nightclub, along with any other demographic information. Additionally, any other information may be displayed as well.

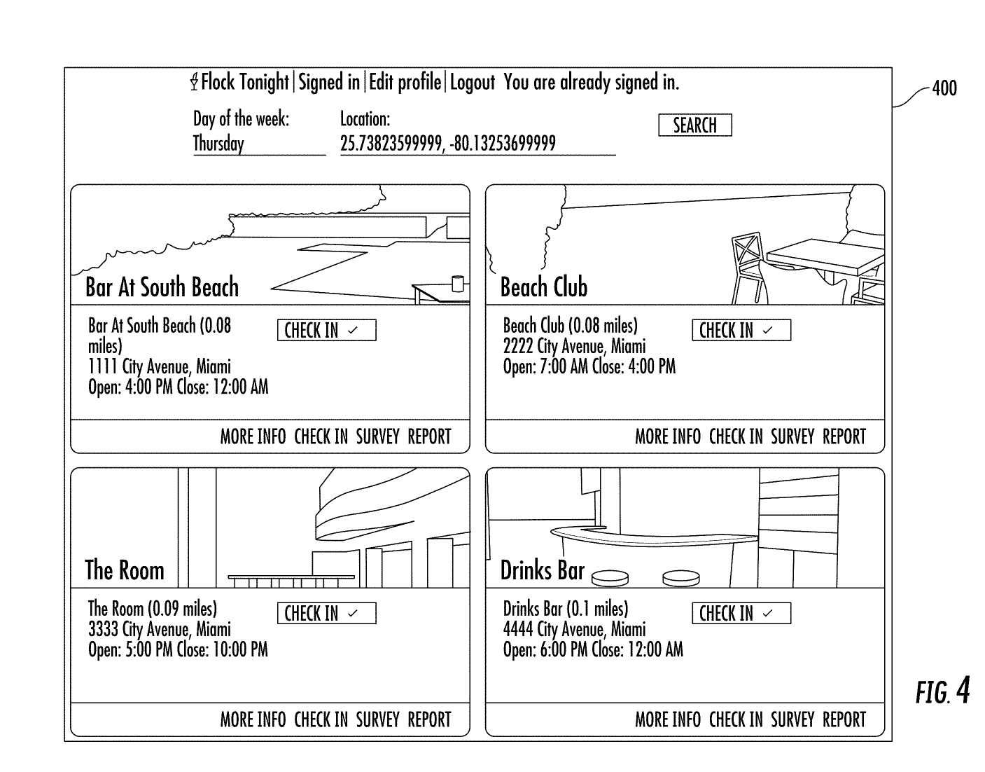

If the first user 101 is within a threshold distance of one or more localities in the set of filtered localities, the system 100 may provide the option to the first user 101 to check into the locality. For example, if the threshold distance is 100 feet from “Alain's Awesome Nightclub” (e.g. second location 116), the system 100 may determine that the first user 101 is currently located within 100 feet of “Alain's Awesome Nightclub.” If the first user 101 is determined to be located within the threshold distance of the locality, the system 100 may provide and display an option for the first user 101 to check into the locality by utilizing the first user device 102. For example, web page 400, as shown in FIG. 4, may be generated and displayed on the first user device 102 to enable the first user 101 to check into “Alain's Awesome Nightclub.” The first user 101 may check into the locality by selecting the option presented on the application being used on the first user device 102. The system 100 may then determine if the first user 101 has checked into the locality. Checking into the locality may occur when the first user 101 selects the option to check into the locality that is displayed on the first user device 102. Checking in may serve as an indication that the first user 101 is confirming that he is at the locality, going to be at the locality, or is going to be at the locality for a certain period of time. In certain embodiments, the first user device 102 may be configured to automatically check the first user 101 into the locality if the first user 101 is within the threshold distance of the locality. If the first user 101 has been determined to have checked into the locality, the system 100 may associate and save the first user's 101 account, the date and time of check in, the day of the week, and the first user's 101 demographic information to the locality's demographic information. For example, if the demographic information of the locality originally indicates that there are two males at the locality, the demographic information of the locality may be automatically updated to indicate that there are now three males at the locality (i.e. the original two males plus the first user 101) after the first user 101 checks into the locality.

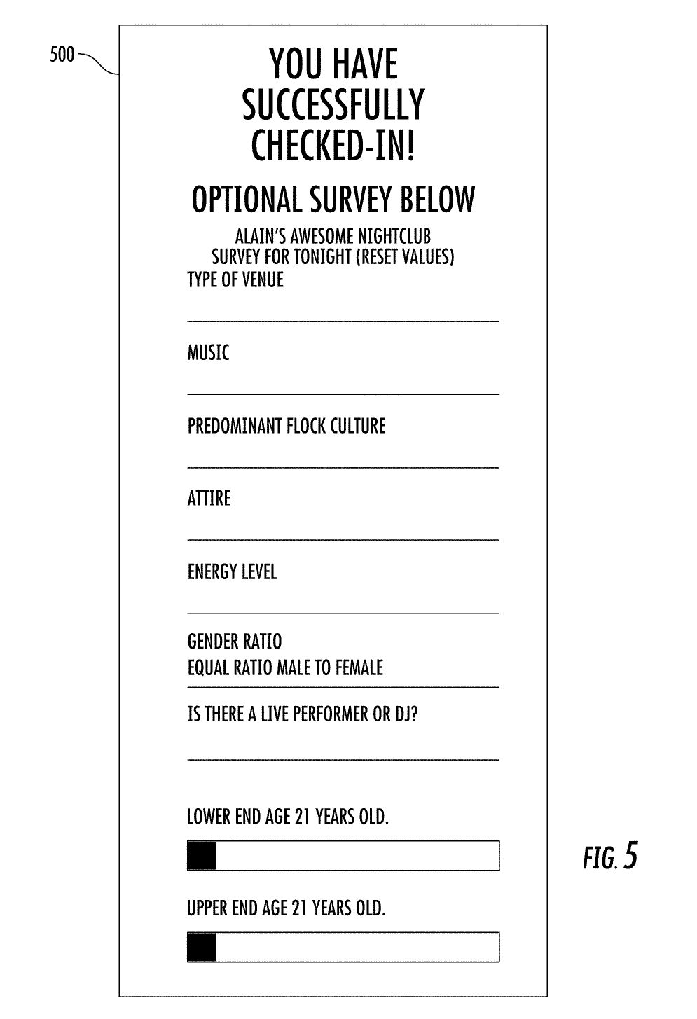

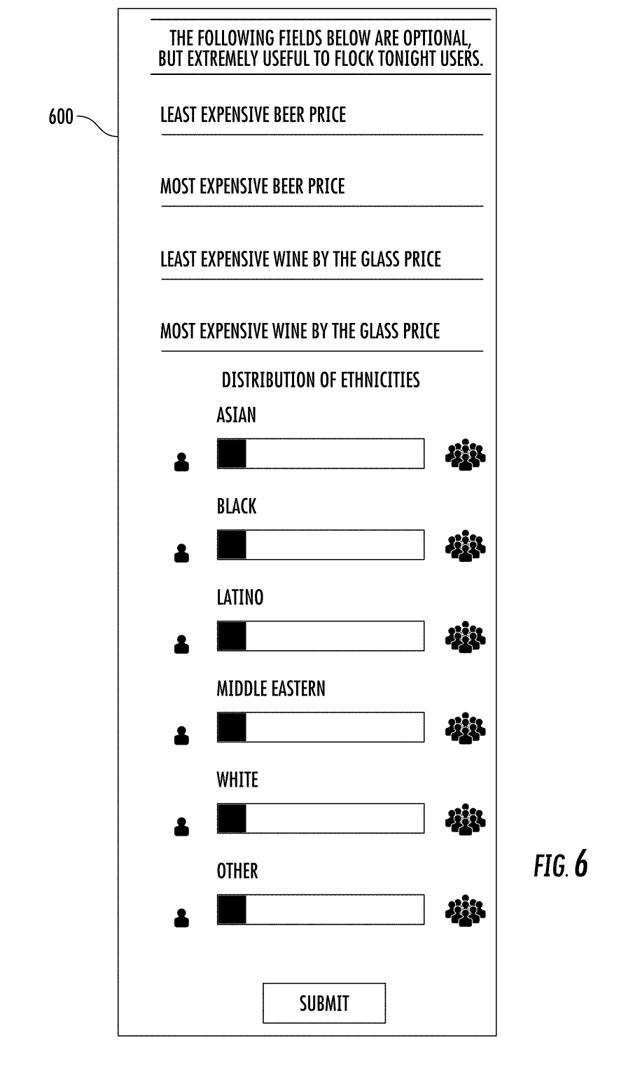

Once checked in, the system 100 may determine if the first user 101 has selected an option to create or participate in a digital survey via the application. If the first user 101 has selected the option to participate in the digital survey, the system 100 may display the digital survey to the first user 101 via the first user device 102 so as to enable the first user 101 to enter demographic information about the locality. An example of a digital survey is shown in web pages 500 and 600, as shown in FIGS. 5-6. In certain embodiments, the first user 101 may enter the demographic information about the locality via first user device 102 into the digital survey. The digital survey may allow the first user 101 to input demographic information, such as, but not limited to, the type of venue that the locality is, the type of music being played at the locality, the type of culture of the individuals at the locality and/or the locality itself (e.g. Average, Chic/Upscale, College, Corporate, Country, Exclusive/Upscale, Dive bar, Family, Hip-Hop, House, Latino, LGBT, Tech/Startup, Sports, Tourist, etc.), the attire of the individuals at the locality (e.g. casual, business smart, trendy, urban, upscale chic, upscale conservative, etc.), the gender ratio of the individuals at the locality (e.g. predominantly female or male, 30% male, 70% female, etc.), whether there is a performer at the locality, an identity of a performer at the locality, an age range of the individuals at the locality (e.g. younger crowd or 21-36 years old, etc.), a heritage of the individuals at the locality, nationality information for the individuals at the locality, a price range of products at the locality, an ethnic distribution of individuals present at the locality, an energy level of the locality (e.g. relaxed, moderate energy, high energy, etc.), any other information associated with the locality, or any combination thereof. The first user 101 may respond to the digital survey provided to the first user 101 via the first user device 102, such as via the application.

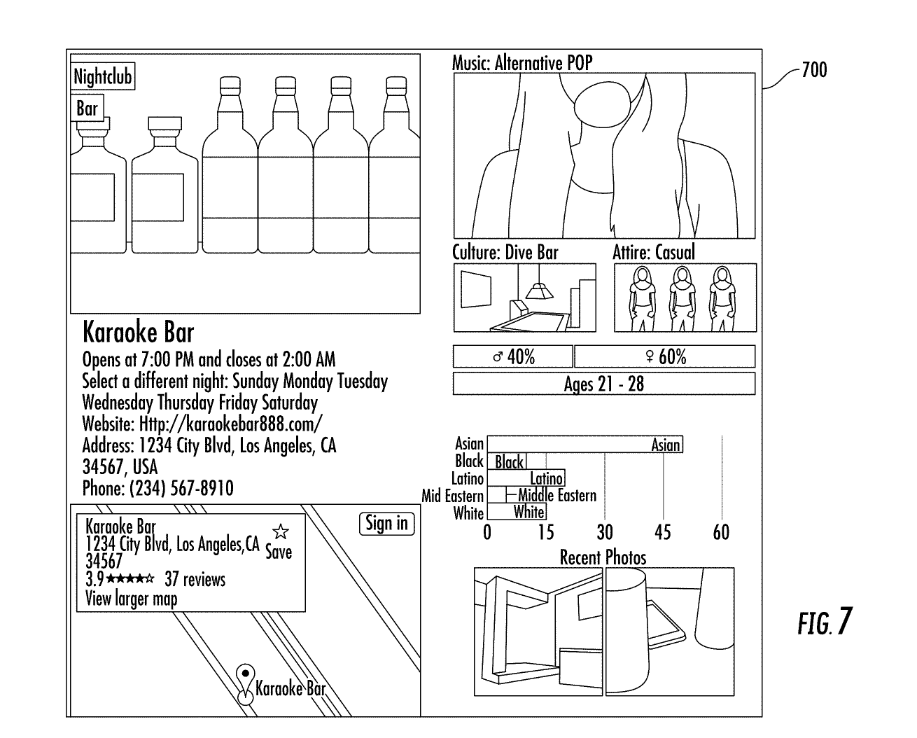

If the first user 101 has responded to the digital survey, the system 100 may average and combine the first user's 101 submitted demographic information to the existing demographic information for the locality and/or demographic information submitted by other users via the digital survey. For example, if before the first user 101 submitted the response to the digital survey, the ethnicity distribution was 30% White, 30% Latino, 30% African American, and 10% Asian, and the first user 101 is Latino, the system 100 may combine this new information to generate a new ethnicity distribution to indicate that the locality now has a slightly higher Latino population based on the check in of the first user 101 at the locality and may reduce the percentages for the other ethnic populations in-real time. The updated ethnicity distribution for the locality may be displayed to a subsequent user that views the same locality in his own locality search results. In this way, as each user in the system 100 submits their own digital survey for a particular locality, the demographic information for the locality may be updated in real-time so that subsequent users may view the changes in demographics for the locality in real-time. Web page 700, as shown in FIG. 7, illustrates example information that may be displayed for a locality in real-time. The web page 700, for example, may indicate how many people have checked into the locality, how many digital surveys have been completed for the locality, the ethnic distribution of individuals at the locality, the age range of individuals at the locality, the energy level at the locality, whether there is a live performer, a price range of beers at the locality, a price range of wines at the locality, operation times for the locality, an address for the locality, a distance of the locality from the first user 101, photos of the locality, video feeds of the locality, the culture type of the locality, the music at the locality, the attire at the locality, any other desired information, or a combination thereof.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, logging into the application, determining a user's location, determining a device's location, determining if GPS is available for a device, determining if a cell tower 125 location is available; determining a location of a user or device based on an internet protocol address; sending location information; determining localities within a threshold distance of a user's location; filtering the determined localities based on a user's preferences and demographic information; displaying the filtered results with demographic information; determining if a user is within a threshold distance of a locality in the filtered results, providing the user with the option to check into the locality via the application; saving the user's demographic information to the locality's demographic information; providing digital surveys; receiving responses to the digital surveys; averaging received demographic information from a user with demographic information for the locality and other demographic information for other users at the locality to update the demographic information for the locality; and performing any other suitable operations conducted in the system 100 or otherwise. In one embodiment, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

Although FIG. 1 illustrates specific example configurations of the various components of the system 100, the system 100 may include any configuration of the components, which may include using a greater or lesser number of the components. For example, the system 100 is illustratively shown as including a first user device 102, a second user device 111, a first location 115, a second location 116, a third location 117, a cell tower 125, a communications network 135, a server 140, a server 150, a server 160, and a database 155. However, the system 100 may include multiple first user devices 102, multiple second user devices 111, multiple first locations 115, multiple second locations 116, multiple third locations 117, multiple cell towers 125, multiple communications networks 135, multiple servers 140, multiple servers 150, multiple servers 160, multiple databases 155, or any number of any of the other components inside or outside the system 100. Furthermore, in certain embodiments, substantial portions of the functionality and operations of the system 100 may be performed by other networks and systems that may be connected to system 100.

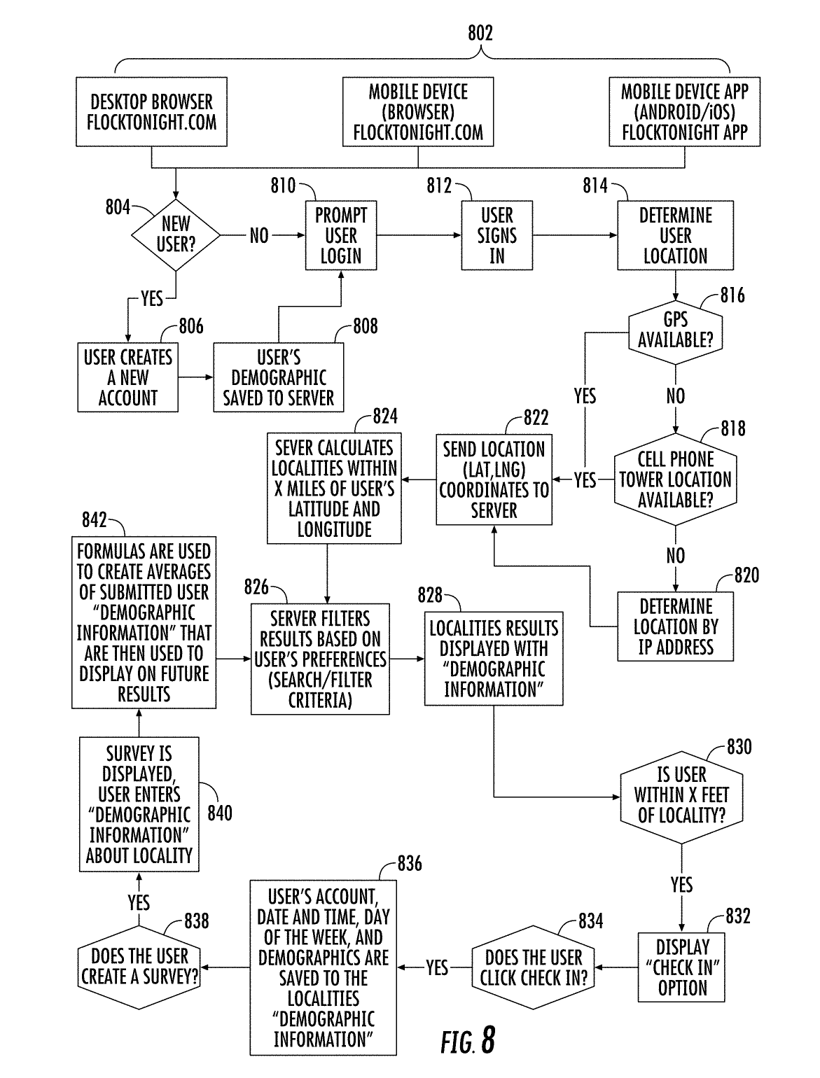

As shown in FIG. 8, an exemplary method 800 for utilizing preferences, demographic information, and other information to curate venues based on data obtained from a variety of sources is schematically illustrated. The method 800 may include, at step 802, accessing an application (i.e. software application) providing and facilitating the functionality of the system 100. In certain embodiments, the accessing of the application may be done in one or more ways. For example, the first user 101 may utilize a desktop browser program executing on the first user device 102 (the first user device 102 being a laptop or desktop computing in this example) to access the application providing the functionality of the system 100, which may be a website or online portal. As another example, the first user 101 may utilize a mobile browser executing on the first user device 102 (the first user device 102 being a smartphone or other mobile device in this example) to access the application providing the functionality of the system 100. As yet another example, the first user 101 may have installed the application (e.g. a mobile application) providing the functionality of the system 100 directly on the first user device 102 so that the first user 101 may directly access the application simply by opening and interacting with the application on the first user device 102. In certain embodiments, the accessing may be performed and/or facilitated by utilizing the first user device 102, the second user device 111, the cell tower 125, the server 140, the server 150, the server 160, the communications network 135, any combination thereof, or by utilizing any other appropriate program, network, system, or device.

At step 804, the method 800 may include determining if the first user 101 accessing the application providing the functionality of the system 100 is a new user. In certain embodiments, the determining may be performed by utilizing the server 140, the server 150, the server 160, the communications network 135, any combination thereof, or by utilizing any other appropriate program, network, system, or device. The first user 101 may be a new user if he has not created an account with the system 100 and/or the application. If the first user 101 is determined to be a new user, the application may provide an option to the user to create a new account with the system 100 and/or application. For example, the option may be presented via the application on the interface 105 of the first user device 102. In order to allow the first user 101 to create the account, at step 806, the application may prompt the first user 101 to enter a username, an electronic messaging address, and a password. Additionally, the application may prompt the first user 101 to enter various demographic information including, but not limited to, a year of birth, a gender, ethnicity information, user preferences, any other information, or any combination thereof. The user preferences may include any type of preference information including, but not limited to, the types of localities or venues preferred by the first user 101, the types of localities that the first user 101 is not interested in, the types of cultural scenes that the first user 101 prefers, types of attire preferred by the first user 101, types of food and beverages preferred and/or not preferred by the first user 101, the types of music preferred and/or not preferred by the first user 101, the age ranges for the people that the first user 101 typically likes to associate with or meet, the first user's 101 preferred energy levels for localities, the first user's 101 preferred ethnic distributions at localities, the first user's 101 preferred gender distributions at localities, the first user's 101 preferred population density at localities, the first user's 101 preferred musicians, the first user's 101 preferred times of operation for localities, the first user's 101 preferred features and amenities provided by a locality, the first user's 101 preferred attractions and/or services available in the vicinity of a locality, any other preferences, or any combination thereof. In certain embodiments, the creation of the account may be performed by utilizing the server 140, the server 150, the server 160, the communications network 135, any combination thereof, or by utilizing any other appropriate program, network, system, or device.

Once the first user 101 has entered the information for creating the account and the account has been created by the system 100, the account, the demographic information, and the preferences may be saved to the system 100. In certain embodiments, the account, the demographic information, and the preferences may be saved to the system 100 by utilizing the server 140, the server 150, the server 160, the database 155, the communications network 135, any combination thereof, or by utilizing any other appropriate program, network, system, or device. After saving the account, the demographic information, and the preferences, the method 800 may include, at step 810, having the application prompt the first user 101 to log into the first user's 101 account. In certain embodiments, the prompting may be performed by utilizing the server 140, the server 150, the server 160, the communications network 135, any combination thereof, or by utilizing any other appropriate program, network, system, or device. At step 812, the method 800 may include having the first user 101 sign into the account via the application. In certain embodiments, the signing in may be performed by utilizing the first user device 102, the second user device 111, the cell tower 125, the server 140, the server 150, the server 160, the communications network 135, any combination thereof, or by utilizing any other appropriate program, network, system, or device.

At step 814, the method 800 may include determining a location of the first user 101. The location of the first user 101 may be determined by determining the location of the device that the first user 101 is using to access the application of the system 100. For example, the device may be first user device 102. The location of the device (and first user 101) may be determined by accessing a GPS receiver of the device, which may be utilized to provide longitude and latitude coordinates corresponding to the location of the device to the application and/or to the system 100. The GPS receiver may receive the longitude and latitude coordinates by pairing with one or more satellites. In certain embodiment, the GPS receiver of the device may be accessed by the application, the cell tower 125, the server 140, the server 150, the server 160, the communications network 135, any combination thereof, or by utilizing any other appropriate program, network, system, or device. In certain embodiments, the location of the device may be determined by obtaining the location from the cell tower 125 that the device is connected to. In certain embodiments, the location of the device may be obtained by utilizing cellular triangulation. In certain embodiments, the location of the device may be determined by utilizing forward link trilateration. In certain embodiments, the location of the device may be determined by measuring a signal strength of a cell connected to the device. In certain embodiments, the location of the device may be obtained by accessing measurements provided by a subscriber identity module of the device. The measurements may include signal-strength measurements, round-trip time measurements, a cell identifier of the cell tower connected to the device, or any combination thereof. In certain embodiments, the location of the device may be determined based on Wi-Fi data obtained from a wireless network connected to the device. In certain embodiments, the location of the device may be determined based on a speech or text input received from the first user 101 via the device. In certain embodiments, the location of the device may be determined based on an internet protocol address of the device or other similar address.

At step 816, the method 800 may include determining if the device (e.g. first user device 102) has GPS functionality available. The determination may include determining if the device has a GPS receiver and/or other GPS functionality. In certain embodiments, the determining may be performed by utilizing the first user device 102, the second user device 111, the cell tower 125, the server 140, the server 150, the server 160, the communications network 135, any combination thereof, or by utilizing any other appropriate program, network, system, or device. If, at step 816, it is determined that the first user device 102 has GPS functionality, the method 800 may proceed to step 822. At step 822, the method 800 may include transmitting the location information obtained from the GPS receiver of the first user device 102 to one or more parts of the system 100 and/or the application. For example, the GPS receiver of the first user device 102 may transmit the location information to the application, which may then transmit the location information to any other component of the system 100. If, however, at step 816, it is determined that GPS functionality for the device is not available, the method 800 may proceed to step 818. At step 818, the method may include determining if the location of a cell tower 125 connected to the device is available. In certain embodiments, the determining of the location of the cell tower 125 may be accomplished by directly obtaining the location information from the cell tower 125 itself, by obtaining the location information from the device connected to the cell tower 125, or a combination thereof. In certain embodiments, the determining may be performed by utilizing the first user device 102, the second user device 111, the cell tower 125, the server 140, the server 150, the server 160, the communications network 135, any combination thereof, or by utilizing any other appropriate program, network, system, or device. If, at step 318, the cell tower 125 location is available and can be determined, the method 800 may proceed to step 822 by transmitting the location information to the application and to the other components of the system 100. If, however, the cell tower 125 location is not available and/or cannot be determined, the method 800 may proceed to step 820.

At step 820, the method 800 may include determining the location of the device (and the first user 101) based on an internet protocol address of the device. In certain embodiments, the location may be determined based on a mapping of the internet protocol address to specific latitude and/or longitude coordinates. The mapping may be obtained from a service provider associated with the device, from the device itself, or both. In certain embodiments, geolocation software may be utilized to deduce the geolocation of the device's internet protocol address. By utilizing such software, the country, city, and zip code of the device's location, along with an identification of the first user 101 assigned to the internet protocol address, may be determined to determine the device's location. In certain embodiments, the determining of the location of the device based on the internet protocol address of the device may be performed by utilizing the first user device 102, the second user device 111, the cell tower 125, the server 140, the server 150, the server 160, the communications network 135, any combination thereof, or by utilizing any other appropriate program, network, system, or device. Once the location is determined based on the internet protocol address at step 820, the method 800 may proceed to step 822, which may include transmitting the longitude and latitude coordinates, along with any other location information (e.g. city, state, address, zip code, block, etc.), to the application and/or to the other components of the system 100. In certain embodiments, the transmitting may be performed by utilizing the first user device 102, the second user device 111, the cell tower 125, the server 140, the server 150, the server 160, the communications network 135, any combination thereof, or by utilizing any other appropriate program, network, system, or device.

At step 824, the method 800 may include calculating and/or determining localities that are within a distance of the user's location. For example, the localities may be calculated based on the distance from the user's latitude and longitude coordinates. The determining may be initiated by a query received from the first user 101 via the application, automatically by the application upon the first user 101 logging into the application and/or system 100, automatically when the device is turned on, or any combination thereof. Localities within the distance may be determined by comparing the user's location information to location information corresponding to the localities, which may reside in database 155. All localities within the distance of the user's location may be determined. In certain embodiments, the localities may be determined by utilizing the first user device 102, the second user device 111, the server 140, the server 150, the server 160, the communications network 135, any combination thereof, or by utilizing any other appropriate program, network, system, or device. At step 826, the method 800 may include filtering the localities based on the first user's 101 preference information, demographic, information, parameters received as input from the first user 101 via the first user device 102, or a combination thereof. For example, if the preference information, demographic information, and/or inputs indicate that the first user 101 prefers localities with patrons having an age range of 21-36 years old, the system 100 may filter the localities determined at step 824 to generate a subset of localities having patrons in the 21-36 year old range. In certain embodiments, the filtering may be performed by utilizing the first user device 102, the second user device 111, the server 140, the server 150, the server 160, the communications network 135, any combination thereof, or by utilizing any other appropriate program, network, system, or device.

At step 828, the method 800 may include causing the filtered locality results to be displayed on the first user device 102 of the first user 101. The results may be displayed via an interface of the application, through a browser program, or a combination thereof. In addition to displaying each locality to the first user 101, demographic information corresponding to each locality may be displayed in proximity to or in the vicinity of the displayed locality. For example, if a certain locality is a restaurant, the age range of the patrons at the restaurant may be displayed in a vicinity of information identifying the restaurant itself. Additionally, other demographic information may be displayed as well. In certain embodiments, the locality results and demographic information may be displayed by utilizing the first user device 102, the second user device 111, the server 140, the server 150, the server 160, the communications network 135, any combination thereof, or by utilizing any other appropriate program, network, system, or device. At step 830, the method 800 may include determining if the first user 101 is within a threshold distance of one or more localities in the set of filtered localities. For example, if the threshold distance is 100 feet, the system 100 may determine that the first user 101 is currently located within 100 feet of a restaurant locality in the set of filtered localities. In certain embodiments, the determining may be performed by utilizing the first user device 102, the second user device 111, the server 140, the server 150, the server 160, the communications network 135, any combination thereof, or by utilizing any other appropriate program, network, system, or device.

If the first user 101 is determined to be located within the threshold distance of a locality, the method 800 may include, at step 832, providing and displaying an option for the first user 101 to check into the locality by utilizing the first user device 102. In certain embodiments, the option to check in may be provided by utilizing the first user device 102, the second user device 111, the server 140, the server 150, the server 160, the communications network 135, any combination thereof, or by utilizing any other appropriate program, network, system, or device. The first user 101 may check into the locality by selecting an option presented on the application being used on the first user device 102. In certain embodiments, the checking in may facilitated by utilizing the first user device 102, the second user device 111, the server 140, the server 150, the server 160, the communications network 135, any combination thereof, or by utilizing any other appropriate program, network, system, or device. At step 834, the method 800 may include determining if the first user 101 has checked into the locality. Checking into the locality may occur when the first user 101 selects the option to check into the locality that is displayed on the first user device 102. Checking in may serve as an indication that the first user 101 is confirming that he is at the locality, going to be at the locality, or is going to be at the locality for a certain period of time. In certain embodiments, the first user device 102 may be configured to automatically check the first user 101 into the locality if the first user 101 is within the threshold distance of the locality. If the first user 101 has been determined to have checked into the locality, the method 800 may include, at step 836, associating and saving the first user's 101 account, the date and time of check in, the day of the week, and the first user's 101 demographic information to the locality's demographic information. For example, if the demographic information of the locality originally indicates that there is one female at the locality that is age 27, the demographic information of the locality may be automatically updated to indicate that there is one female at the locality that is age 27 and one male (i.e. the first user 101) that is also at the locality that is age 35 after the first user 101 checks into the locality. In certain embodiments, the associating and saving may be performed by utilizing the first user device 102, the second user device 111, the server 140, the server 150, the server 160, the communications network 135, any combination thereof, or by utilizing any other appropriate program, network, system, or device.

At step 838, the method 800 may include determining if the first user 101 has selected an option to create or participate in a digital survey via the application. The option may be presented via the application to the first user 101 via the first user device 102 after the first user 101 has checked into the locality. In certain embodiments, the option to participate in the digital survey may be provided to the first user 101 by utilizing the first user device 102, the second user device 111, the server 140, the server 150, the server 160, the communications network 135, any combination thereof, or by utilizing any other appropriate program, network, system, or device. If the first user 101 has selected the option to participate in the digital survey, the method 800 may include, at step 840, displaying the digital survey to the first user 101 via the first user device 102 so as to enable the first user 101 to enter demographic information about the locality. In certain embodiments, at step 840, the first user 101 may enter the demographic information about the locality via first user device 102. The digital survey may allow the first user 101 to input demographic information, such as, but not limited to, the type of venue that the locality is, the type of music being played at the locality, the type of culture of the individuals at the locality and/or the locality itself, the attire of the individuals at the locality, the gender ratio of the individuals at the locality, whether there is a performer at the locality, an identity of a performer at the locality, an age range of the individuals at the locality, a heritage of the individuals at the locality, nationality information for the individuals at the locality, a price range of products at the locality, an ethnic distribution of individuals present at the locality, an energy level of the locality (e.g. relaxed, moderate energy, high energy, etc.), any other information associated with the locality, or any combination thereof. In certain embodiments, the displaying of the digital survey may be performed by utilizing the first user device 102, the second user device 111, the server 140, the server 150, the server 160, the communications network 135, any combination thereof, or by utilizing any other appropriate program, network, system, or device. The first user 101 may respond to the digital survey provided to the first user 101 via the first user device 102, such as via the application.

If the first user 101 has responded to the digital survey, the method 800 may include, at step 842, averaging and/or combining the first user's 101 submitted demographic information to the existing demographic information for the locality and/or demographic information submitted by other users via the digital survey. For example, if before the first user 101 submitted the response to the digital survey, the age range was 21-36, but the first user 101 submitted that the age range was 25-37, the submitted age range 25-37 may be averaged with the previous age range of 21-36 to generate a new updated real-time age range for the locality. The updated real-time age range for the locality may be displayed to a subsequent user that may view the same locality in his own locality search results. In this way, as each user in the system 100 submits their own digital survey for a particular locality, the demographic information for the locality may be updated in real-time so that subsequent users may view the changes in demographics for the locality in real-time. In certain embodiments, the averaging and/or combining may be performed by utilizing the first user device 102, the second user device 111, the server 140, the server 150, the server 160, the communications network 135, any combination thereof, or by utilizing any other appropriate program, network, system, or device. Notably, the method 800 may further incorporate any of the features and functionality described for the system 100 or as otherwise described herein.

The systems and methods disclosed herein may include additional functionality and features. For example, the operative functions of the system 100 and method may be configured to execute on a special-purpose processor specifically configured to carry out the operations provided by the system 100 and method. Notably, the operative features and functionality provided by the system 100 and method may increase the efficiency of computing devices that are being utilized to facilitate the functionality provided by the system 100 and method 800. For example, through the use of the automatic calculation and/or determination of the localities within a threshold distance of a user when the user logs into the application, a reduced amount of computer operations need to be performed by the devices in the system 100 using the processors and memories of the system 100 than if the users have to specifically request the calculation and/or determinations as a separate step. In such a context, less processing power needs to be utilized because the processors and memories do not need to be dedicated for processing such requests. As a result, there are substantial savings in the usage of computer resources by utilizing the software and algorithms provided in the present disclosure.

Notably, in certain embodiments, various functions and features of the system 100 and methods may operate without any human intervention and may be conducted entirely by computing devices. In certain embodiments, for example, multiple computing devices may interact with devices of the system 100 to provide the functionality supported by the application and/or the system. Additionally, in certain embodiments, the computing devices of the system 100 may operate continuously and without human intervention to reduce the possibility of errors being introduced into the system 100. In certain embodiments, the system 100 and methods may also provide effective computing resource management by utilizing the features and functions described in the present disclosure. For example, in certain embodiments, upon receiving inputs in response to the digital survey or any other inputs to the application, any selected device in the system 100 may transmit a signal to a computing device receiving or processing the input that only a specific quantity of computer processor resources (e.g. processor clock cycles, processor speed, etc.) may be devoted to processing the input, any other operation conducted by the system 100, or any combination thereof. For example, the signal may indicate an amount of processor cycles of a processor may be utilized to process the input, and/or specify a selected amount of processing power that may be dedicated to processing the input or any of the operations performed by the system 100. As another example, the signal may indicate an amount of processing resources of a processor that may be utilized for generating the averages of the submitted user demographic information, filtering results based on user preferences, displaying results, determining the user's and/or device's location, any other operation conducted by the system 100, or any combination thereof. In certain embodiments, a signal indicating the specific amount of computer processor resources or computer memory resources to be utilized for performing an operation of the system 100 may be transmitted from the first and/or second user devices 102, 111 to the various components of the system 100.

In certain embodiments, any device in the system 100 may transmit a signal to a memory device to cause the memory device to only dedicate a selected amount of memory resources to the various operations of the system 100. In certain embodiments, the system 100 and methods may also include transmitting signals to processors and memories to only perform the operative functions of the system 100 and methods at time periods when usage of processing resources and/or memory resources in the system 100 is at or below a threshold value. In certain embodiments, the system 100 and methods may include transmitting signals to the memory devices utilized in the system 100, which indicate which specific portions of the memory should be utilized to store any of the data utilized or generated by the system 100. Notably, the signals transmitted to the processors and memories may be utilized to optimize the usage of computing resources while executing the operations conducted by the system 100. As a result, such features provide substantial operational efficiencies and improvements over existing technologies.

In certain embodiments, instead of and/or in addition to displaying a survey to a user of the first user device 102 to obtain demographic and/or other information about a locality, the application executing on the first and/or second user device 102, 111 may provide an option to load a media application and/or media functionality of the first and/or second user device 102, 111 so that media content associated with the locality may be captured. For example, if the first user 101 has checked into a locality and is approaching the entrance of the locality, the application executing on the first user device 102 may display an option to capture media content associated with the locality. If the option is selected, the first user device 102 may load a media application such as a camera application to allow the first user to take videos, and/or photographs of the entrance of the locality, the interior of the locality, the individuals at the locality, the outside perimeter of the locality, or any combination thereof. In certain embodiments, the media application may enable the media application to capture audio being outputted at the locality.

Based on the media content captured by the media application and/or functionality, the application executing on the first user device 102 may be configured to analyze the media content to detect individuals in the media content, the type of décor at the locality, the energy level of the locality (e.g. relaxed, lively, energetic, etc.), the ambiance of the locality, the age of the individuals in the locality, the type of music being played at the locality, an identification of the specific music being played at the locality, an ethnic distribution at the locality, a gender ratio at the locality, a type of food present at the locality, any other information disclosed in the presented disclosure or otherwise, or any combination thereof. For example, if the media content is video content that includes a song being played by a disc jockey and people dancing near a table with food on it, the application may determine an identify of the song being played by comparing the sounds in the music video with sounds contained in sound files and/or songs in a music library stored in the database 155. Similarly, the application may determine that there are three people based on using an image recognition algorithm and/or a graphics processor of the system 100. The application may also determine the gender of each individual detected in the media content by comparing the images of the individuals detected in the media content and comparing their similarity to images and/or media stored in database 155 that is known to be associated with a specific gender. For example, if the first individual detected in the media content has a threshold similarity to an image and/or video known to be of a female, the application may determine that the first individual detected in the media content is also female. Using the example above, the application may analyze the food in the media content and compare its similarly to images and/or other media content in database 155 to determine an identity of the food in the media content above. For example, using the example above, the application may determine that the food item in the media content captured at the locality is a steak based on the food item having a threshold similarity to an image of a steak in the database 155. Similarly, other aspects of the locality, such as the ambiance, energy level, etc., may also be determined based on similar comparisons to image, audio, and/or other media content accessible by the system 100 and/or application.

In certain embodiments, the systems and methods may also include machine learning capabilities. For example, the system 100 may include a learning engine and/or module that may be software, hardware, or a combination thereof. The learning engine may determine patterns and/or associations associated with characteristics of localities based on the demographic information and/or media content obtained for a locality. For example, the learning engine may determine that based on an analysis of media content (and/or demographic information or other information inputted into and/or accessible by the system 100) obtained at a locality over time, that the locality has an older range of patrons during winter months as opposed to summer months. Similarly, the learning engine may determine based on an analysis of the media content and/or other information that music played at the locality changes based on the time of day, the time of year, and the day of the week. Still further, the learning engine may determine any pattern associated with any information described in the present disclosure. For example, the learning engine may determine that the gender ratio is more skewed towards males on Friday nights and females on Saturday nights. Based on the information gathered and determined by the learning engine, the system 100 may update the information for each locality in real-time and provide even more valuable information to the users of the system 100. The updated information may be displayed and/or otherwise outputted to the users of the system 100 in real-time. Additionally, in certain embodiments, feedback confirming, denying, and/or modifying the patterns and associations determined by the learning engine may be received by the users of the system 100, the devices of the system 100, or a combination thereof, to further optimize the performance of the learning engine over time.

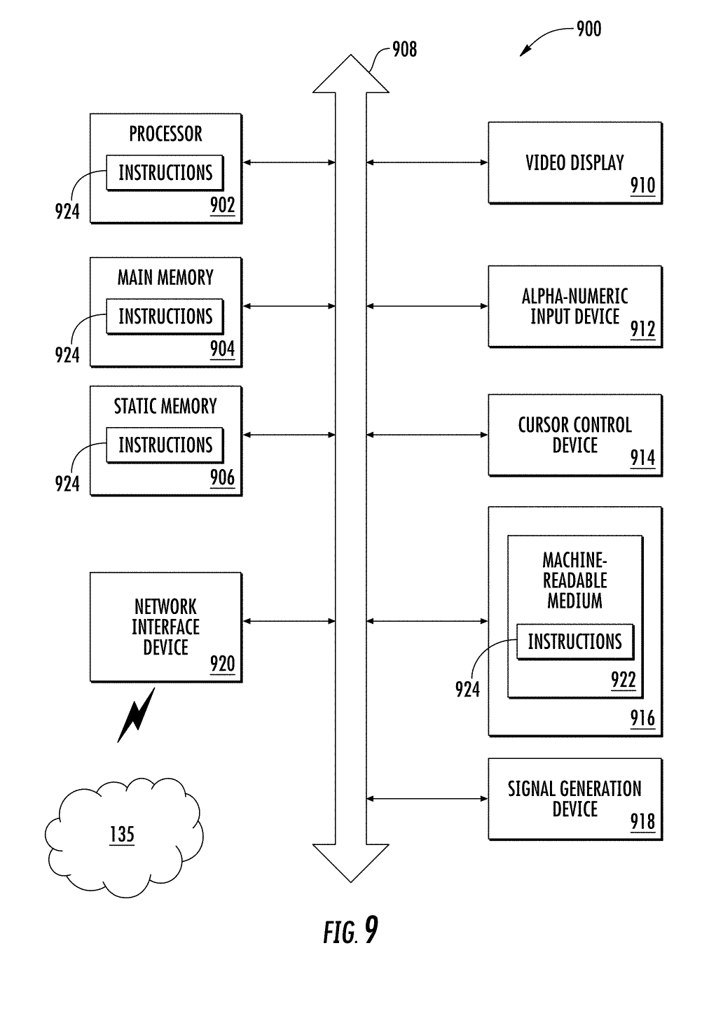

Referring now also to FIG. 9, at least a portion of the methodologies and techniques described with respect to the exemplary embodiments of the system 100 can incorporate a machine, such as, but not limited to, computer system 900, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100.

In some embodiments, the machine may operate as a standalone device. In some embodiments, the machine may be connected (e.g., using communications network 135, another network, or a combination thereof) to and assist with operations performed by other machines and systems, such as, but not limited to, the first user device 102, the second user device 111, the cell tower 125, the server 140, the server 150, the database 155, the server 160, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 900 may include a processor 902 (e.g., a central processing unit (CPU), a graphics processing unit (GPU, or both), a main memory 904 and a static memory 906, which communicate with each other via a bus 908. The computer system 900 may further include a video display unit 910, which may be, but is not limited to, a liquid crystal display (LCD), a flat panel, a solid state display, or a cathode ray tube (CRT). The computer system 900 may include an input device 912, such as, but not limited to, a keyboard, a cursor control device 9414, such as, but not limited to, a mouse, a disk drive unit 916, a signal generation device 918, such as, but not limited to, a speaker or remote control, and a network interface device 920.

The disk drive unit 916 may include a machine-readable medium 922 on which is stored one or more sets of instructions 924, such as, but not limited to, software embodying any one or more of the methodologies or functions described herein, including those methods illustrated above. The instructions 924 may also reside, completely or at least partially, within the main memory 904, the static memory 906, or within the processor 902, or a combination thereof, during execution thereof by the computer system 900. The main memory 904 and the processor 902 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 922 containing instructions 924 so that a device connected to the communications network 135, another network, or a combination thereof, can send or receive voice, video or data, and communicate over the communications network 135, another network, or a combination thereof, using the instructions. The instructions 924 may further be transmitted or received over the communications network 135, another network, or a combination thereof, via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A system, comprising:
a memory that stores instructions; and
a processor that executes the instructions to perform operations, the operations comprising:
receiving, from a communication device, demographic information and preferences corresponding to a user;
determining, based information associated with the communication device, a location of the user;
calculating, based on the location of the user, a plurality of localities within a first threshold distance of the location of the user;
filtering, based on the demographic information and the preferences, the plurality of localities to obtain a subset of localities relevant to the user;
causing the subset of localities and locality demographic information specific to each locality in the subset of localities to be displayed on the communication device;
determining, based on the information associated with the communication device, if the user is within a second threshold distance of a first locality of the subset of localities;
providing, to the communication device and if the user is within the second threshold distance of the first locality, an option to check into the first locality;
associating, if the option to check into the first locality is selected, the demographic information of the user to the first locality; and
updating locality demographic information specific to the first locality based on the demographic information of the user that has been associated with the first locality.

2. The system of claim 1, wherein the operations further comprising determining the location of the user based on an internet protocol address of the communication device.

3. The system of claim 1, wherein the operations further comprise determining the location of the user based on global positioning data obtained from a global positioning receiver of the communication device.

4. The system of claim 1, wherein the operations further comprise determining the location of the user based on determining a cell tower location of a cell tower connected to the communication device.

5. The system of claim 1, wherein the operations further comprise generating a digital survey for receiving additional demographic information associated with the first locality, and wherein the operations further comprise transmitting the digital survey to an application executing on the communication device.

6. The system of claim 5, wherein the operations further comprise receiving, in response to the digital survey, the additional demographic information from the communication device.

7. The system of claim 6, wherein the operations further comprise updating the updated locality demographic information specific to the first locality based on the additional demographic information received from the communication device.

8. The system of claim 7, wherein the operations further comprise displaying the updated locality information specific to the first locality on a different communication device of a different user that accesses the system after the communication device of the user.

9. The system of claim 1, wherein the operations further comprise enabling the user to create an account with the system.

10. The system of claim 9, wherein the operations further comprise saving the demographic information and the preferences to the account.

11. The system of claim 1, wherein the demographic information comprises gender ratio information, age range information, culture information, ethnicity distribution information, attire information, nationality information, heritage information, energy level information, music information, pricing information, venue information, or any combination thereof.

12. A method, comprising:
receiving, from a communication device, demographic information and preferences corresponding to a user;
determining, based information associated with the communication device, a location of the user;
calculating, based on the location of the user, a plurality of localities within a first threshold distance of the location of the user, wherein the calculating is performed by a processor that executes instructions from a memory;
filtering, based on the demographic information and the preferences, the plurality of localities to obtain a subset of localities relevant to the user;
causing the subset of localities and locality demographic information specific to each locality in the subset of localities to be displayed on the communication device;
determining, based on the information associated with the communication device, if the user is within a second threshold distance of a first locality of the subset of localities;
providing, to the communication device and if the user is within the second threshold distance of the first locality, an option to check into the first locality;
associating, if the option to check into the first locality is selected, the demographic information of the user to the first locality; and
updating locality demographic information specific to the first locality based on the demographic information of the user that has been associated with the first locality.

13. The method of claim 13, further comprising determining the location of the user based on an internet protocol address of the communication device.

14. The method of claim 13, further comprising determining the location of the user based on global positioning data obtained from a global positioning receiver of the communication device.

15. The method of claim 13, further comprising determining the location of the user based on determining a cell tower location of a cell tower connected to the communication device.

16. The method of claim 13, further comprising generating a digital survey for receiving additional demographic information associated with the first locality.

17. The method of claim 16, further comprising operations transmitting the digital survey to an application executing on the communication device.

18. The method of claim 17, further comprising updating the updated locality demographic information specific to the first locality based on additional demographic information received from the communication device in response to the digital survey.

19. The method of claim 18, further comprising displaying the updated locality information specific to the first locality on a different communication device of a different user that accesses the system after the communication device of the user.

20. A computer-readable device comprising instructions, which when loaded and executed by a processor, cause the processor to perform operations comprising:
receiving, from a communication device, demographic information and preferences corresponding to a user;
determining, based information associated with the communication device, a location of the user;
calculating, based on the location of the user, a plurality of localities within a first threshold distance of the location of the user;
filtering, based on the demographic information and the preferences, the plurality of localities to obtain a subset of localities relevant to the user;
causing the subset of localities and locality demographic information specific to each locality in the subset of localities to be displayed on the communication device;
determining, based on the information associated with the communication device, if the user is within a second threshold distance of a first locality of the subset of localities;
providing, to the communication device and if the user is within the second threshold distance of the first locality, an option to check into the first locality;
associating, if the option to check into the first locality is selected, the demographic information of the user to the first locality; and
updating locality demographic information specific to the first locality based on the demographic information of the user that has been associated with the first locality.
